(19) United States
(12) Patent Application Publication
(10) Pub. No.: US 2026/0304555 A1
(43) Pub. Date: Oct. 1, 2026

(54) MANAGEMENT AND REPORTING OF CHANGE IN CONFIGURATION APPLICABILITY IN A WIRELESS COMMUNICATION SYSTEM

(71) Applicant: SHARP KABUSHIKI KAISHA, Sakai City (JP)

(72) Inventors: Rudraksh Shrivastava, Erligheim (DE); Sudeep Hegde, Stuttgart (DE); Tomoki Yoshimura, Camas, WA (US)

(21) Appl. No.: 19/092,999

(22) Filed: Mar. 27, 2025

(51) Int. Cl. H04W 76/38; H04W 56/00

(52) U.S. Cl. CPC H04W 76/38; H04W 56/0045

(57) ABSTRACT

A user equipment (UE) that includes one or more non-transitory computer-readable media storing one or more computer-executable instructions and at least one processor coupled to the one or more non-transitory computer-readable media is provided. The UE configures a timer based on a configuration received from a base station (BS). The UE receives, from the BS, a set of one or more configurations. The UE starts the timer. The UE determines that at least one configuration in the set of one or more configurations is inapplicable. The UE transmits, to the BS, a set of one or more messages that includes an applicability status of the set of one or more configurations. The timing of the transmission of the set of one or more messages with respect to the expiration of the timer indicates a cause for the one inapplicable configuration.

### TECHNICAL FIELD

The technology generally relates to wireless communications, and more particularly to reporting causes of configuration inapplicability in a wireless communication system.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5th generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the integration of artificial intelligence/machine learning (AI/ML) continues to expand in the 5G NR networks, it has become crucial for user equipment (UE) to accurately discern its serving and neighboring cells'AI/ML functionalities, for example, to ensure smooth handoffs, timely activation of relevant features, and efficient allocation of network resources. However, challenges emerge from dynamic network conditions, as the availability and capabilities of neighboring cells may vary due to factors such as traffic load and interference. In addition, the UE's own capabilities, internal conditions, model availability, and the inherent complexity of the 5G NR networks (e.g., including integrated access and backhaul (IAB) systems) further complicate this assessment. To accurately determine the applicable functionalities of neighboring base stations (e.g., next-generation Node Bs (gNBs)) and cells, the UE has to be provided with relevant network-side information, including the appropriate timing for assessing neighboring cell functionalities and the methods for reporting this information back to the network. Reporting neighboring cell AI/ML functionality information may introduce signaling overhead that may affect the network performance.

As the demand for radio access continues to grow, however, there is a need for further improvements in wireless communications in the next-generation radio communication systems, such as improvements in the network mobility management.

### SUMMARY

In a first aspect of the present application, a UE is provided. The UE includes one or more non-transitory computer-readable media storing one or more computer-executable instructions; and at least one processor coupled to the one or more non-transitory computer-readable media. The at least one processor is configured to execute the one or more computer-executable instructions to cause the UE to perform the following. Configure a timer, to the UE, based on a configuration received from a base station (BS); receive, from the BS, a set of one or more configurations; start the timer; determine that at least one configuration in the set of one or more configurations is inapplicable; and transmit, to the BS, a set of one or more messages that includes an applicability status of the set of one or more configurations. The timing of the transmission of the set of one or more messages with respect to an expiration of the timer indicates a cause for the at least one inapplicable configuration in the set of one or more configurations.

In an implementation of the first aspect, transmitting the set of one or more messages that includes the applicability status of the set of one or more configurations includes the following. In a case that the inapplicability of the at least one configuration is due to a UE-side issue: transmitting, to the BS, a first message that includes the applicability status of the set of one or more configurations after the expiration of the timer, and in a case that the inapplicability of the at least one configuration is not due to a UE-side issue: transmitting, to the BS, a second message that includes the applicability status of the set of one or more configurations before the expiration of the timer.

In another implementation of the first aspect, the at least one processor is further configured to execute the one or more computer-executable instructions to cause the UE to: determine that at least one configuration in the set of one or more configurations is applicable. Transmitting the set of one or more messages that include the applicability status of the set of one or more configurations includes the following. In a case that the inapplicability of the at least one configuration is not due to a UE-side issue: transmitting, to the BS, a first message that includes the applicability status of the at least one configuration in the set of one or more configurations that is applicable before the expiration of the timer, and transmitting, to the BS, a second message that includes the applicability status of the at least one configuration in the set of one or more configurations that is inapplicable before the expiration of the timer.

In another implementation of the first aspect, transmitting the set of one or more messages that includes the applicability status of the set of one or more configurations further includes the following. In a case that the inapplicability of the at least one configuration is due to a UE-side issue: transmitting, to the BS, a first message that includes the applicability status of the at least one configuration in the set of one or more configurations that is applicable before the expiration of the timer, and transmitting, to the BS, a second message that includes the applicability status of the at least one configuration in the set of one or more configurations that is inapplicable after the expiration of the timer.

In another implementation of the first aspect, transmitting the set of one or more messages that includes the applicability status of the set of one or more configurations further includes the following. In a case that the inapplicability of the at least one configuration is due to a UE-side issue: transmitting, to the BS, a first message that includes the applicability status of the at least one configuration in the set of one or more configurations that is applicable after the expiration of the timer, and transmitting, to the BS, a second message that includes the applicability status of the at least one configuration in the set of one or more configurations that is inapplicable before the expiration of the timer.

In another implementation of the first aspect, the timer is a first timer. The at least one processor is further configured to execute the one or more computer-executable instructions to cause the UE to: determine a change in the applicability or inapplicability of a first configuration in the set of one or more configurations, start a second timer, in a case that the inapplicability of the at least one configuration is due to a UE-side issue: transmit, to the BS, a first messages that includes the applicability status of the set of one or more configurations after the expiration of the second timer, and in a case that the inapplicability of the at least one configuration is not due to a UE-side issue: transmit, to the BS, a second messages that includes the applicability status of the set of one or more configurations before the expiration of the second timer.

In another implementation of the first aspect, the timer is a first timer. The at least one processor is further configured to execute the one or more computer-executable instructions to cause the UE to: determine that at least one configuration in the set of one or more configurations is applicable, start a second timer, in a case that the inapplicability of the at least one configuration is not due to a UE-side issue: transmit, to the BS, a first message that includes the applicability status of the at least one configuration in the set of one or more configurations that is applicable before the expiration of the second timer, and transmit, to the BS, a second message that includes the applicability status of the at least one configuration in the set of one or more configurations that is inapplicable before the expiration of the second timer.

In another implementation of the first aspect, the at least one processor is further configured to execute the one or more computer-executable instructions to cause the UE to perform the following. In a case that the inapplicability of the at least one configuration is due to a UE-side issue: transmit, to the BS, a first message that includes the applicability status of the at least one configuration in the set of one or more configurations that is applicable before the expiration of the second timer, and transmit, to the BS, a second message that includes the applicability status of the at least one configuration in the set of one or more configurations that is inapplicable after the expiration of the second timer.

In a second aspect of the present application, a UE is provided. The UE includes one or more non-transitory computer-readable media storing one or more computer-executable instructions; and at least one processor coupled to the one or more non-transitory computer-readable media. The at least one processor is configured to execute the one or more computer-executable instructions to cause the UE to perform the following. Receive, from the BS, a group of configurations; determine that a first set of one or more configuration in the group of configurations is applicable and a second set of one or more configuration in the group of configurations is inapplicable; transmit, to the BS, a first applicability status of the first and second sets configurations; start a timer; in a case that the UE determines one or more configuration in the first set of configurations has become inapplicable, and no inapplicability is due to a UE-side issue: transmit, to the BS, the applicability status of the first and second sets of configurations before an expiration of the timer; and in a case that the UE determines at least one configuration in the first set of configurations has become inapplicable due to a UE-side issue: transmit, to the BS, the applicability status of the first and second sets of configurations after the expiration of the timer.

In an implementation of the second aspect, the at least one processor is further configured to execute the one or more computer-executable instructions to cause the UE to perform the following. In a case that the UE determines no change in the applicability of the second set of configurations prior to the expiration of the timer: transmit, to the BS, a message indicating a persistent inapplicability of the configurations in the second set of one or more configurations.

In another implementation of the second aspect, the at least one processor is further configured to execute the one or more computer-executable instructions to cause the UE to perform the following. In a case that the UE determines no change in the applicability of the second set of one or more configurations prior to the expiration of the timer: transmit no applicability status to the BS to imply a persistent inapplicability of the configurations in the second set of one or more configurations.

In another implementation of the second aspect, the at least one processor is further configured to execute the one or more computer-executable instructions to cause the UE to: determine at least one configuration in the second set of one or more configurations has become applicable; transmit, to the BS, the applicability status of the first and second sets of configurations; activate the at least one configuration in the second set of one or more configurations; remove the at least one configuration from the second set of one or more configurations; and in case that any configuration in the second set of one or more configurations remains inapplicable: restart the timer for the second set of one or more configurations.

In another implementation of the second aspect, starting the timer includes starting the timer in response to receiving, from the BS, an indication to start the timer.

In another implementation of the second aspect, starting the timer includes starting the timer by the UE based on a default configuration.

In a third aspect of the present application, a method is provided. The method includes configuring a timer, by a UE, based on a configuration received from a BS; receiving, by the UE, from the BS, a set of one or more configurations; determining, by the UE, that at least one configuration in the set of one or more configurations is inapplicable; starting, by the UE, the timer; and transmitting, by the UE, to the BS, an applicability status of the set of one or more configurations, The timing of the transmission of the applicability report with respect to an expiration of the timer indicates a cause for the at least one inapplicable configuration in the set of one or more configurations.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIG. 2 is a sequence diagram illustrating an example message flow of a signaling framework for applicable functionality reporting for a beam management UE side model, according to an example implementation of the present disclosure.

FIG. 3 illustrates a flowchart of an example method/process of reporting causes of configuration or functionality inapplicability, according to an example implementation of the present disclosure.

FIG. 4 is a sequence diagram illustrating a portion of an example message flow of a signaling framework for reporting the applicable functionality after the (in)applicability timer expires, according to an example implementation of the present disclosure.

FIG. 5 is a sequence diagram illustrating a portion of an example message flow of a signaling framework for reporting the applicable functionality before the (in)applicability timer expires, according to an example implementation of the present disclosure.

FIG. 6 is a sequence diagram illustrating a portion of an example message flow of a signaling framework for reporting the applicable functionality before the (in)applicability timer expires and reporting the inapplicable functionality after the (in)applicability timer expires, according to an example implementation of the present disclosure.

FIG. 7 is a sequence diagram illustrating a portion of an example message flow of a signaling framework for reporting the inapplicable functionality before the (in)applicability timer expires and reporting the applicable functionality after the (in)applicability timer expires, according to an example implementation of the present disclosure.

FIG. 8 is a sequence diagram illustrating a portion of an example message flow of a signaling framework for reporting the (in)applicable functionality using an (in)applicability monitoring timer, according to an example implementation of the present disclosure.

FIG. 9 illustrates a flowchart of an example method/process of monitoring and reporting causes of change in configuration or functionality applicability, according to an example implementation of the present disclosure.

FIG. 10 illustrates a flowchart of an example method/process of monitoring and reporting causes of change in configuration or functionality applicability based an (in)applicability monitoring timer, according to an example implementation of the present disclosure.

FIG. 11 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), LTE-A Pro, and/or a new radio system referred to as 6G. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), a 6G Node B (6gNB), and any other apparatus capable of controlling radio communication and managing radio resources within a cell. The BS may connect to serve the one or more UEs through a radio interface to the network.

The BS may be operable to provide radio coverage to a specific geographical area using one or more cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR or 6G is to support flexible configurations for accommodating various next generation communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR or 6G waveform. The scalable OFDM numerology, such as the adaptive sub-carrier spacing, the channel bandwidth, and the Cyclic Prefix (CP) may also be used. Additionally, two coding schemes are considered for NR or 6G: (1) Low-Density Parity-Check (LDPC) code and (2) Polar Code. The coding scheme adaption may be configured based on the channel conditions and/or the service applications.

Moreover, it should also be noted that in a transmission time interval of a single NR or 6G frame, a DL transmission period, a guard period, and UL transmission data may at least be included, where the respective portions of the DL transmission data, the guard period, and the UL transmission data should also be configurable, for example, based on the network dynamics of NR or 6G. In addition, sidelink resources may also be provided in an NR or 6G frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e\hat{ }GX. Here, e is the Napier number. Also, (HX)\hat{ }(IX) indicates IX to the power of HX.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.
Antenna Panel: It may be assumed that an antenna panel is an operational unit for controlling a transmit spatial filter/beam. An antenna panel typically includes several antenna elements. A beam may be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.
BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.
TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.
Panel: The UE panel information may be derived from the TCI state/UL beam indication information or from the network signaling.
Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.
TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).
TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.
TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.
TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.
Frequency Division Multiplexing (FDM) based PDSCH repetition: Multiple PDSCHs with the same TB but corresponding to two TCI states. These PDSCHs are allocated to non-overlapping frequency resources within a slot.
Multi-DCI based PDSCH scheme: Two PDCCHs from separate search spaces associated with different CORESET pool indexes that schedule the corresponding PDSCHs.
Single Frequency Network (SFN) based PDCCH scheme: A CORESET is associated with two different beams.
SFN based PDSCH scheme: A PDSCH is associated with two different beams.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.
Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication.” The “DL only” and “UL only” may also be referred to as a “separate TCI state,” as opposed to the “joint TCI state.”

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected, as the representative AI/ML sub-use cases. The first use case (BM-Case1) may include spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the network side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or Rx beam ID.

The second use case (BM-Case2) may include temporal downlink beam prediction for Set A of beams based on the historic measurement results of Set B of beams. For the BM-Case2, the following alternatives may be considered. The AI/ML model training and inference may be done either at the network side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like KPIs, the AI/ML model may provide output in the form of F (f1,f2 . . . fn) predictions for T(t1,t2, . . . tn) future time instances. The prediction may reflect predicted beams and their corresponding configurations.

RAN work group 2 (RAN WG2 or RAN2), during phase 1 discussions, has defined different functionality types for AI/ML functionalities. A functionality may refer to an AI/ML-enabled feature, or feature group, facilitated by a configuration. A functionality, in the context of AI/ML-enabled 5G NR and beyond communication systems, may refer to a specific feature, or a collection of related features, that is enabled by artificial intelligence or machine learning capabilities. These functionalities are supported and managed through configurations, which are sets of parameters or instructions that dictate how the AI/ML enabled a 5G NR (or beyond) system should operate. Essentially, a configuration ensures that the functionality works correctly by providing the necessary settings and data for the AI/ML processes including the life cycle Management (LCM) of the AI/ML model/functionality to work effectively.

Technical document TR 38.843 (Study on Artificial Intelligence (AI)/Machine Learning (ML) for NR air interface) provided the following definitions for the AI/ML models:
AI/ML-enabled Feature: Refers to a Feature where AI/ML may be used.
AI/ML Model: A data driven algorithm that applies AI/ML techniques to generate a set of outputs based on a set of inputs.
AI/ML model Inference: A process of using a trained AI/ML model to produce a set of outputs based on a set of inputs.
Model activation: Enable an AI/ML model for a specific AI/ML-enabled feature.
Model deactivation: Disable an AI/ML model for a specific AI/ML-enabled feature.
Two-sided (AI/ML) model: A paired AI/ML Model(s) over which joint inference is performed, where joint inference includes AI/ML Inference whose inference is performed jointly across the UE and the network, i.e., the first part of inference is first performed by UE and then the remaining part is performed by gNB, or vice versa.
UE-side (AI/ML) model: An AI/ML model whose inference is performed entirely at the UE.

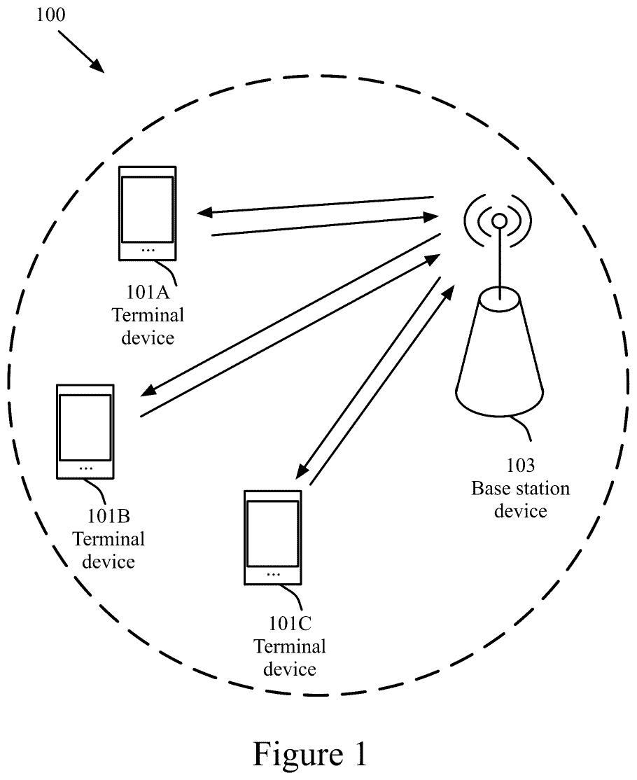

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When the BS 103 is configured with multiple transmission/reception devices, each of the multiple transmission/reception devices may be arranged at a different position. A transmission/reception device may include a transmission device and/or a reception device.

The BS 103 may serve radio communication and provide one or more cells. A cell is defined in this disclosure as a set of resources used for a wireless communication. A cell may include one or both of a downlink component carrier and an uplink component carrier. A serving cell may include a downlink component carrier and two or more uplink component carriers.

The BS 103, or another network entity, such as a location management function (LMF) server, in some embodiments, may provide multiple sets of configurations to the UE 101A-101C for a given AI/ML functionality. The BS 103, or the other network node, may provide a mechanism to change the configuration sets based on changes in the UE's environment and/or additional conditions.

In a wireless communication system, the RRC configuration process may be used for setting up, maintaining, and modifying the radio connection between the UE and the BS (e.g., a gNB) in the 5G/5G-Advanced (5G-A) networks. The BS 103 or the network entity, may send an RRC message to a UE 101A-101C to configure at least one of the configuration parameters or features of a configuration set. This RRC message may be, for example, RRCSetup, RRCReconfiguration, RRCResume, RRCRelease, or other downlink messages generated by the BS 103 or another network entity. The BS 103 and/or the other network entities are considered as components of the network. In the following discussions, the term network, or network node, refers to any network entity, such as, BS (e.g., gNB), LMF server, etc., and the BS 103 may be used as an example of such network node.

The term “configuration,” herein, may refer to the arrangement and specification of components, settings, or parameters within a system or device, as defined by the applicable agreements, standards, or specifications. The term configuration may encompass the established setup and customization of elements necessary to ensure compliance with contractual obligations, operational requirements, and performance criteria.

In the context of CSI reporting and RRC reconfiguration procedures in the 5G and beyond wireless networks, when the UE receives an RRC Reconfiguration message from the BS (e.g., the gNB), it may autonomously activate the applicable functionalities (especially in case of periodic CSI reporting). However, if one or more configurations provided by the BS are inapplicable due to UE-side conditions (e.g., hardware limitations, environmental conditions, or capability restrictions), in the current 3GPP scenario, the UE reports the inapplicability without specifying the cause.

This may result in several challenges:
Repeated Reconfiguration Attempts by the BS: The BS may continuously attempt to reconfigure the UE, assuming the inapplicability is temporary or resolvable. This may lead to redundant RRC Reconfiguration messages.
Unnecessary Signaling Overhead: Repeated reconfiguration attempts may result in inefficient use of air interface resources, causing unnecessary signaling overhead and wasteful consumption of network resources.
Increased Latency: Valid reconfiguration procedures may be delayed, increasing the overall latency for network operations.
UE Power Drain: Frequent reconfiguration attempts may lead to increased power consumption on the UE, affecting the battery life.
Inefficient Resource Allocation: The BS may misallocate resources, assuming that the

UE may eventually support the requested configuration, leading to suboptimal resource distribution and potential network inefficiencies.
Unstable RRC State: Persistent reconfiguration attempts may result in an unstable RRC state at the UE, further complicating network management.

The above-mentioned problems arise from a lack of detailed feedback regarding the cause of inapplicability, which prevents the BS from understanding whether the issue is temporary or permanent, or whether the issue is due to the UE side conditions or other factors. As a result, the BS may misinterpret the inapplicability as a temporary issue and continue to send reconfiguration requests, which further exacerbates the signaling overhead and other network inefficiencies.

This disclosure addresses the above-mentioned issues by providing a mechanism to accurately monitor and identify the inapplicability of configurations and functionalities in real-time using RRC messages or UE Assistance Information (UAI). This includes the following:
Identifying the specific causes of inapplicability, whether they are due to the UE-side conditions or other factors.
Enabling the BS to differentiate between temporary and persistent inapplicability to avoid unnecessary reconfiguration attempts.
Assist in data collection and model training procedures.
Reducing signaling overhead, network load, and power consumption by ensuring that resources are efficiently allocated, and reconfigurations are only attempted when appropriate.

Since the applicability of a given functionality depends on various factors, which mainly include the UE-sided conditions, the functionality configuration may result in ambiguous behavior when the UE-sided conditions are not visible to the network. When the UE does not report the exact cause for (in)applicability of a certain functionality to be configured, the network may, for example, keep trying to configure the functionality with a different set of sub-parameters. This may result in increased signaling and may reduce the overall system performance for the network and the UE. The term (in)applicability is used herein to refer to applicability or inapplicability. The present disclosure provides several methods to enhance the signaling mechanisms when the network configures a UE with the AI/ML functionalities and the associated sub-configurations.

In the present disclosure, several options are described to configure the UE to implicitly or explicitly inform the network on the cause behind a given (in)applicability report to be sent to the network. In the case of explicit indication, the UE, for example, may provide the network with a binary indication on whether the cause for (in)applicability is due to the UE-sided conditions, and further whether the UE applies a fallback configuration because of the (in)applicability. Additionally, several options are described to explicitly indicate to the network the cause for (in)applicability with standardized error codes. In the implicit indication options, the UE may be configured to provide the (in)applicability report either as a part of a an RRC message, such as, RRCReconfigurationComplete message, or a UAI, either jointly or separately, with each of the sub-options implicitly indicating to the network on the possible cause for (in)applicability. In some embodiments, persistent (in)applicability messages may also be used as implicit or explicit indications to the network. Providing the network with exact or implicit indications for (in)applicability provides the technical advantage of increasing the signaling efficiency and improving the performance of the AI/ML functionalities.

The present disclosure further describes several timer-based methods to be used for the UE transmissions of (in)applicability reports to report any changes in applicability of an AI/ML-functionality or configuration. The introduced timers (e.g., the (in)applicability monitoring timer (IMT)) aim to specify at which point in time, after detecting the changes in applicability, the UE may generate (in)applicability reports, based on which the network may implicitly or explicitly derive the cause for (in)applicability of the associated functionality.

### Reporting Causes of Functionality or Configuration Inapplicability

In a discussion on the applicability conditions, RAN2 has assumed that the terminology “additional conditions” used in RAN1 is equal to “applicability conditions” captured in the Technical Report TR 38.843. This means that an AI/ML functionality/model may be applicable under certain configurations, scenarios, and/or datasets. According to RAN1 discussion, the following applicability conditions may be applied:
Certain scenarios (e.g., channel model, UE distribution, UE mobility levels, carrier frequencies, etc.)
Certain configurations (e.g., UE/gNB config, bandwidths, antenna port layouts)
Certain sites
The UE's internal conditions such as memory, battery, and other hardware limitations

During the discussion, several companies had diverse opinions on the applicability conditions scope and terminology. So far, a consensus has not been reached. Therefore, RAN2 may need to discuss and clarify applicability conditions, related issues, terminology and define its scope.

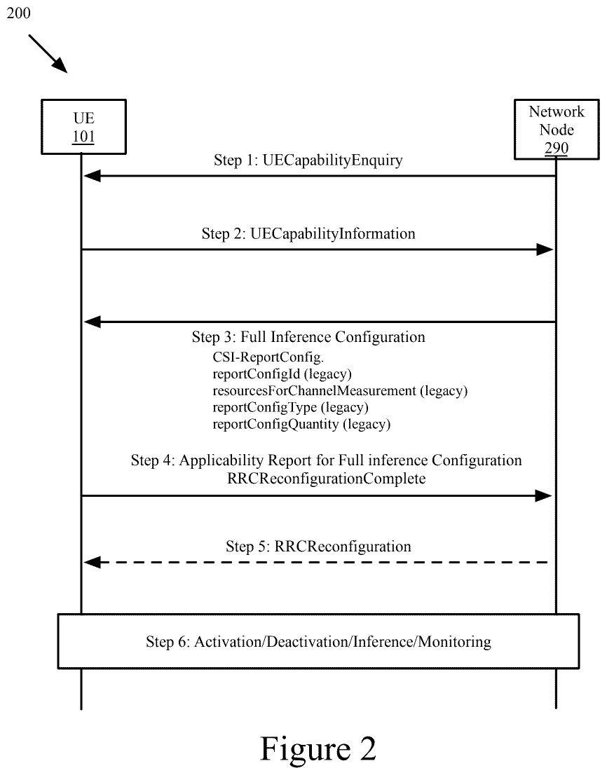

In this disclosure, the beam management scenario is used as a non-limiting example to describe the reporting of applicable functionalities for the AI/ML modeling. FIG. 2 is a sequence diagram 200 illustrating an example message flow of a signaling framework for applicable functionality reporting for a beam management UE side model, according to an example implementation of the present disclosure.

The wireless communications system may be, for example, a 3GPP network, such as, the 5G/5G-A or the 6th generation (6G) NR system. The UE 101 may be any of the UEs 101A-101C and the network node 290 may be the BS 103 shown in FIG. 1 or any other network entity, for example, an LMF server.

As agreed in RAN2 meeting #127, in Step 1, the network node 290 may send the UECapabilityEnqiry message to initiate the procedure to the UE 101 reporting the UE's AI/ML supported functionalities. In Step 2, the UE 101 may send, to the network node 290, the UECapablityInformation message that may include the supported functionalities at the UE side.

In Step 3, the network node 290 may provide the UE 101with full inference configuration, which may include one or more configurations (e.g., CSI-ReportConfig., in case of Beam Management use case, and one or more legacy configurations). The network node 290 may configure the UE 101 to report its applicable functionalities.

In Step 4, the UE 101 may transmit the applicability report for full inference configuration to the network node 290. The applicability report, in some embodiments, may be transmitted by an RRC message, such as the RRCReconfigurationComplete message. In other embodiments, a UAI message may be used instead of an RRC message to imply the cause of one or more configuration inapplicability to the network node 290.

As described further below, in different embodiments, the UE 101 may use one or more of the followings to indicate the cause of a functionality or configuration inapplicability. The UE 101 may provide an explicit or implicit fallback indication to the network node 290. The UE 101 may use a UAI in the initial report instead of an RRC message (e.g., the RRCreconfig. message). The UE 101 may use a new message, or a new filed, introduced in the UAI or the RRC message, to indicate the UE is ready to receive new configurations. The UE 101 may use a persistent inapplicability indication or a failure indication. In some embodiments, the repeated inapplicability reports by the UE 101 may be interpreted by the network 290 as the existent of a UE-side issue or a persistent issue. The UE 101 may use standardized error codes to report the cause of inapplicability.

In Step 5, the network node 290 may send an updated configuration or an (de)activation command (e.g., using MAC CE or DCI) for the applicable functionalities to the UE.

In Step 6, the UE 101 may start inference/monitoring based on the configuration.

The UE behavior upon receiving a full configuration may be as follows. When Full Configuration is provided in Step 3 and the UE is configured with periodic CSI reporting, the UE may autonomously activate the applicable functionalities upon reporting the applicable functionalities via an RRC message (e.g., the RRCReconfigurationComplete) in Step 4 (i.e., without the need to wait for the RRCReconfiguration in Step 5). Once the UE 101 receives one or more full configurations, the UE 101 may send the initial applicability report in an RRC message, such as, the RRCReconfigurationComplete message. After the initial configuration, a UAI may be sent to update the status of the applicability. The applicability and inapplicability, in some embodiments, may be explicitly or inexplicitly reported to the network node 290.

As per current UE behavior in the 3GPP standard, the cause of inapplicability is not reported. To solve this shortcoming, the present disclosure provides several new methods or solutions to manage applicability change of an AI/ML functionality or configuration including reporting of the functionality or configuration inapplicability cause or state of the UE that may result in persistent or long-term inapplicability of one or more functionalities or configurations. Particularly due to conditions on the UE side, but also including other possible factors, as described herein.

In the present disclosure, the terms “functionality” and “configuration” may be used interchangeably. However, both are included within the scope of the invention.

As described above, according to RAN1 discussion, the following applicability conditions may be applied:
Certain scenarios (e.g., channel model, UE distribution, UE mobility levels, carrier frequencies, etc.)
Certain configurations (e.g., UE/gNB config, bandwidths, antenna port layouts)
Certain sites
The UE's internal conditions such as memory, battery, and other hardware limitations

Therefore, based on the applicability conditions such as the ones mentioned above, a functionality or configuration may be deemed applicable or inapplicable.

The present disclosure considers the following two main cases as examples (but not excluding other cases):
Case 1: In the applicability report in Step 4, the UE reports all configurations or functionalities as inapplicable, for example, due to the UE side conditions.
Case 2: In the applicability report in Step 4, the UE reports some but not all (e.g., one or more) configurations or functionalities as inapplicable, for example, due to the UE side conditions or other reasons, as discussed above.

The following methods (or solutions) may be used by different embodiments to indicate to the network the repeated or persistent inapplicability of functionalities and configurations.

### Solution 1

In Solution 1, it is assumed that the BS provides a fallback configuration (e.g., in “other config”) alongside with the primary AI/ML configurations.

When all the configurations or functionalities are inapplicable, the UE may send an inapplicability report to the network (e.g., in Step 4, shown in FIG. 2) indicating that all configurations are inapplicable and with an indication, for example, a fallback indication in the RRCReconfigurationcomplete, CSIreportConfig., etc., indicating that a legacy configuration has been activated. In this case two options may be considered.
Option 1 (With Fallback indication): If the UE reports inapplicability and includes an indication that implies the legacy configuration or a default AI/ML configuration is activated (e.g., with a FallbackApplied field), this may imply that the UE is not able to apply the network provided AI/ML configuration due to its own constraints (UE-side problem) instead of any other cause. This may also mean that the inapplicability may persist until the UE side limitations are resolved.

In one example, this may be indicated by simply including a legacy configuration or a default AI/ML configuration in the applicable functionality list. Hence, if the network is informed that only legacy configuration or a default AI/ML configuration is applicable and all others are inapplicable, it may imply that UE is using a legacy configuration or a default AI/ML configuration. In some cases, the network may send an (de)activation command to activate the applicable configuration.
Option 2 (Without Fallback Indication): When the UE reports applicability or inapplicability of a functionality or configuration (e.g., an AI/ML-based configuration) but does not include an explicit indication like a “FallbackApplied” field, this omission may implicitly indicate that the issue is not due to the UE-side constraints. For example, the UE may provide a report listing both applicable functionalities (those the UE can use) and inapplicable functionalities (those the UE cannot use). The applicability or inapplicability may be indicated either explicitly using a “FallbackField” or implicitly by adding or skipping a configuration in the applicability or inapplicability list. If the UE has applied a legacy configuration (or another fallback AI/ML configuration) as a workaround, the UE may choose not to list this legacy configuration in either the applicable or inapplicable functionality lists. In such cases, the UE may still apply the legacy configuration silently but does not explicitly indicate this in the (in)applicability report.

The BS, upon receiving this report without a fallback indication—either explicitly (e.g., a “FallbackApplied” field) or implicitly (e.g., the UE listing the legacy configuration as applicable)—may interpret it as follows: the UE cannot apply the provided AI/ML configuration due to reasons other than its own limitations, such as a BS misconfiguration (e.g., incorrect parameters) or external factors (e.g., environmental interference). Thus, the absence of a fallback indication in the report, whether through the “FallbackField” or either the inclusion or the skipping of a configuration in the lists, may imply the issue is not UE-specific, even though the UE may still be using a fallback or default configuration (AI/ML-based or non-AI/ML) without reporting it.

It should be noted that Options 1 and 2 may also be used in the opposite manner. For example, the absence of the fallback indication may imply the UE-side issue and the presence of the fallback indication may imply other issues than the UE side issues. It should also be noted that the applicability or inapplicability may be indicated either explicitly using a “FallbackField applied/not applied” or implicitly by adding or skipping a configuration in the applicability or inapplicability list, for example, in the UAI or the RRC messages. In should further be noted that, the present disclosure uses the UE-side issue just as an example, and other causes or issues may lead to inapplicability of a functionality or configuration.

In some embodiments, the network may provide a prioritized list of fallback configurations (e.g., in OtherConfig) during initial setup or Step 3 shown in FIG. 2. Examples of fallback configurations in such a list may include:
Fallback 1: Simplified 5G NR config.
Fallback 2: Legacy 5G NR config.
Fallback 3: LTE baseline (if dual connectivity is supported).

The UE may autonomously select and activate the highest-priority fallback the UE supports. The UE may, or may not, report its choice to the BS, depending on the implementation. This approach may prevent the case where every configuration is inapplicable including the legacy configurations.
Option 3: Silent Fallback Activation: In this method, the UE may report inapplicability using the UAI and/or an RRC message, such as, the RRC reconfiguration complete message, and activate a fallback configuration (e.g., the legacy CSI-ReportConfig) but may not report it. The BS may detect this implicitly through the UE's subsequent behavior (e.g., the CSI reports matching the legacy format) rather than an explicit UE statement.

In some embodiments, the UE may activate a fallback configuration and may report it in the (in)applicability report implying no UE side issue or vice-versa. For example, the BS may notice the UE's CSI reports align with a legacy config, implying the UE fell back due to an unstated issue.
Option 4: Minimal Reporting Content: In this method, the UE may send a bare-bones inapplicability report (e.g., just a flag like ConfigInapplicable=True) without additional details. The lack of elaboration may imply the issue lies with the UE, leaving the BS to deduce the cause. For example, the UE may report “Inapplicability=True” with no reason code or fallback status, implying a UE-side constraint.

In some embodiments, the UE may send an RRC message (e.g., the RRCReconfigurationComplete message) or the UAI without the (in)applicability report. The absence of (in)applicability report may imply that UE is not ready to use the AI/ML functionality.

In some embodiments, the UE may send the RRC message (e.g., the RRCReconfigurationComplete message)or the UAI indicating just legacy configuration as applicable and everything else either empty, absent, or marked as inapplicable.

### Solution 2

As per current RAN2 agreement, once the UE receives one or more full configurations in Step 3, shown in FIG. 2, the UE sends the initial applicability report in an RRC message (e.g., the RRCReconfigurationComplete message). After the initial configuration, the UAI may be sent to update the status of the applicability.

However, in case the inapplicability is due to the UE-side conditions or issues, the UE may report inapplicability differently as follows. The initial (in)applicability report may be sent in the UAI instead of an RRC message (e.g., the RRCReconfigurationComplete message). The UAI may be included in the RRCreconfigurationcomplete message or sent separately. This may implicitly indicate the UE side issues or persistent inapplicability. It should be noted that the role of the RRC and UAI messages may be reversed. For example, if the (in)applicability report message is typically sent in UAI, then an RRC message (e.g., the RRCReconfigurationComplete message) may be used to send the (in)applicability report to implicitly indicate the UE side issues or persistent inapplicability.

In a case that the report is not an initial (in)applicability report, a new UAI or RRC message or a new field in a new UAI or RRC message may be used to report the (in)applicability.

When the UE-side issue is resolved, a new message or a new filed may be introduced in UAI or RRC message or configuration indicating that the UE is ready to receive new configurations. This new message may be used to indicate resolution of any issue and is not limited to just the UE-side issues.

### Solution 3

This solution is applicable to both Case 1, where the UE reports all configurations or functionalities as inapplicable and Case 2, where the UE reports some but not all (e.g., one or more) configurations or functionalities as inapplicable.

A new filed may be added with an indication, such as, Persistent_inapplicability or a failure indication in the UAI or the RRC message (e.g., the RRCReconfigurationcomplete) indicating the UE-side issues or persistent inapplicability.

In some embodiments, this may be reported per configuration or functionality, for example, per CSI-ReporConfig. This may be applied in Case 2. Failure indication may be sent if one or more or all configurations/functionalities are inapplicable.

Some embodiments may add a 1-bit “persistentInapplicability or failure” field in the (in)applicability report within the RRC message (e.g., the RRCReconfigurationComplete) or the UAI or per configuration or functionality, for example, CSI-ReportConfig.

### Solution 4

Repeated Inapplicability Reports: If the UE repeatedly sends inapplicability reports for every BS-provided configuration (including fallbacks), this pattern may implicitly suggest a persistent UE-side issue (e.g., capability mismatch) without the need for an explicit cause. For example, after several (e.g., three) consecutive InapplicabilityReport messages, the BS may infer the UE cannot support any advanced features.

This solution is applicable to both Case 1, where the UE reports all configurations or functionalities as inapplicable and Case 2, where the UE reports some but not all (e.g., one or more) configurations or functionalities as inapplicable. In case 2, if a large number or percentage of configurations are being reported inapplicable, the BS may imply instability in the UE conditions and/or environment.

### Solution 5

Some embodiments may use standard error codes, flags, or indications to report the cause for inapplicability of a functionality or configuration. In some embodiments, a new field may be introduced in, for example, the CSI-ReportConfig to report the cause for inapplicability of a functionality or configuration. For example, the UE may receive a configuration for periodic, aperiodic, or semi-persistent reporting via the CSI-ReportConfig with a ReportConfigType set and also with cause reporting (for inapplicability) set to yes or no. The granularity of the cause may be per configuration or group of configurations, for example, UAI, RRC etc.

In some embodiments, the network may request the UE to report the cause using DCI, MAC CE, or RRC message (in case the (in)applicability report does not have cause included in it). In this case, the DCI, MAC CE, or RRC message may need to be enhanced to include a field, such as, reportCause field.

Some embodiments may introduce standardized error codes. For example, the 3GPP standard may be modified to define specific error codes for CSI configuration failures that the UE may use to report it to the network. The examples of such error codes may include (but not limited to):
Unsupported frequency band
Insufficient UE processing power
Resource conflict with other UE processes
CSI-RS resource unavailable
Outdated AI/ML model
UE power constraint or low power level

In some embodiments, when a functionality or configuration becomes applicable from the inapplicable state, the reason for applicability may also be reported. This is opposite of the case for providing the reason for inapplicability. In these embodiments, the provided codes may indicate the reason why a functionality or configuration has become applicable. For example, the codes may indicate improvements in conditions, such as, the UE side conditions, model availability, or change in scenarios, such as channel model, UE distribution, UE mobility levels, carrier frequencies, etc.

In some embodiments, detailed error messages may allow the UE to provide short, descriptive error messages along with the error codes. Some embodiments may allow the UE to explicitly signal whether the inapplicability is persistent (e.g., due to fixed hardware or capability issues) or temporary via a binary flag in its inapplicability report. Some embodiments may use enhanced RRC, UAI, or special IEs CSI reports.

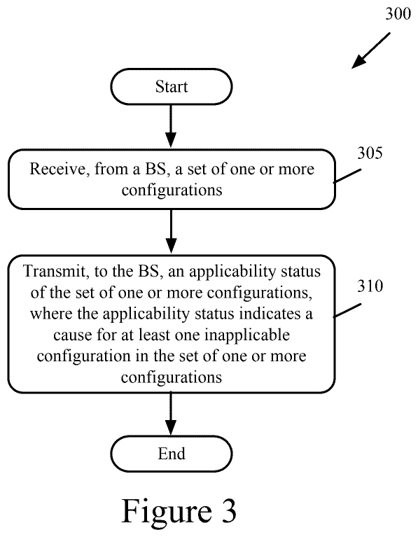

FIG. 3 illustrates a flowchart of an example method/process 300 of reporting causes of configuration or functionality inapplicability, according to an example implementation of the present disclosure. The process 300 may be performed by at least one processor of the terminal device 101, shown in FIG. 2.

The process 300 may receive (at block 305), from a BS, a set of one or more configurations. The process 300 may transmit (at block 310), to the BS, an applicability status of the set of one or more configurations, where the applicability status indicates a cause for at least one inapplicable configuration in the set of one or more configurations. The process 300 may then end.

The set of one or more configurations received at block 305, in some embodiments, may include at least one fallback configuration. In these embodiments, indicating the cause includes indicating the fallback configuration as an applicable configuration for the at least one inapplicable configuration. As described above with reference to Solution 1, indicating the fallback configuration as an applicable configuration implies, to the BS, whether the cause of the at least one inapplicable configuration is a UE-side issue. In some embodiments, indicating the fallback configuration as an applicable configuration may imply a UE-side issue, while in other embodiments, indicating the fallback configuration as an applicable configuration may imply an issue other than a UE-side issue.

The set of one or more configurations, in some embodiments, may further include one or more AI/ML configuration, and the fallback configuration may include a legacy non-AI/ML configuration or a default AI/ML configuration.

In some embodiments, at least one fallback configuration includes a prioritized group of fallback configurations. In these embodiments, the process 300 may activate the highest priority fallback configuration, in the group of fallback configurations, that the UE supports for the at least one inapplicable configuration.

In some embodiments (such as, Solution 1, described above), the set of one or more configurations may include at least one fallback configuration, and indicating the cause may include not including the fallback configuration as an applicable configuration for the at least one inapplicable configuration to imply, to the BS, whether the cause of the at least one inapplicable configuration is a UE-side issue. In some embodiments, not including the fallback configuration as an applicable configuration may imply a UE-side issue, while in other embodiments, not including the fallback configuration as an applicable configuration may imply an issue other than a UE-side issue.

In some embodiments (such as Solution 2, described above), the applicability status may be an initial applicability status transmitted by the UE (at block 310), to the BS, in a UAI message. Transmitting the initial applicability status in the UAI message instead of an RRC message may imply, to the BS, whether the cause of the at least one inapplicable configuration is a UE-side issue. In some embodiments, Transmitting the initial applicability status in the UAI message instead of an RRC message may imply a UE-side issue, while in other embodiments, Transmitting the initial applicability status in the UAI message instead of an RRC message may imply an issue other than a UE-side issue.

In some embodiments (such as Solution 3, described above), the cause may include a UE-side issue or a persistent issue. The at least one inapplicable configuration may include a first configuration. Indicating the cause may include transmitting (at block 310), to the BS, a message indicating the inapplicability of the at least one inapplicable configuration without indicating an explicit cause. The message may include a set of one or more fields to indicate the inapplicability. The process 300 may determine that the cause is resolved, may activate the first configuration, and may transmit, to the BS, a message indicating the UE is ready to receive new configurations. Each field in the set of one or more fields, in some embodiments, may include a bit indicating whether the corresponding configuration is applicable or inapplicable.

In some embodiments (such as Solution 4, described above), transmitting (at block 310) the applicability status indicating a cause for at least one inapplicable configuration may include transmitting, to the BS, a message indicating the inapplicability of the at least one inapplicable configuration without indicating an explicit cause, receiving (at block 305), from the BS, another set of one or more configurations, and repeating the transmitting the message and the receiving another set of one or more configurations several times.

In some embodiments (such as Solution 5, described above), transmitting (at block 310) the applicability status indicating a cause for at least one inapplicable configuration may include transmitting, to the BS, a message indicating the cause of the inapplicability in a field reserved for reporting the cause of inapplicability.

In some embodiments (such as Solution 5, described above), transmitting (at block 310) the applicability status indicating a cause for at least one inapplicable configuration may include transmitting, to the BS, a message indicating the inapplicability of the at least one inapplicable configuration without indicating an explicit cause, receiving, from the BS, a message requesting the UE to report a cause for the inapplicability, and transmitting, to the BS, a message indicating the cause of the inapplicability in a field reserved for reporting the cause of inapplicability. The message indicating the cause of the inapplicability may include a DCI message, a MAC CE message, or an RRC message.

In some embodiments (such as Solution 5, described above), transmitting (at block 310) the applicability status indicating a cause for at least one inapplicable configuration may include transmitting, to the BS, a message that includes an error code indicating the cause of the inapplicability in a field reserved for reporting the cause of inapplicability. The error code may include an unsupported frequency band, an insufficient UE processing power, a resource conflict with a UE process, a CSI-RS resource unavailable, an outdated AI/ML model, a UE power constraint, or a low UE power level.

### Monitoring and Reporting Causes of Change in Functionality or Configuration Applicability

### Solution 6

Some embodiments may provide a UE-side timer for monitoring applicability changes. The network may configure a timer within the UE to specify a time window during which the UE is required to report its configuration or functionality applicability status.

The UE may continuously assess the applicability of its configurations and functionalities and prepare a detailed status report for transmission to the network within the network-configured timer duration.

Upon receiving a full inference configuration from the network, the UE may send an initial applicability report in an RRC message, such as, the RRCReconfigurationComplete message, detailing which functionalities are applicable and which are inapplicable. Several cases are described below.

### Case 1

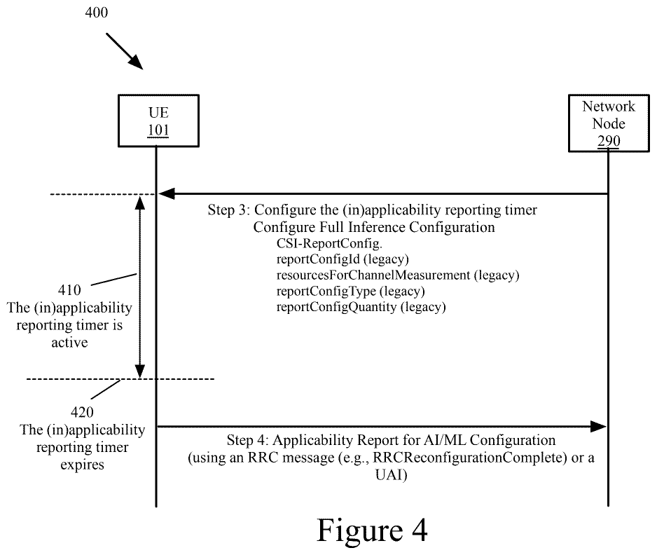

FIG. 4 is a sequence diagram 400 illustrating a portion of an example message flow of a signaling framework for reporting the applicable functionality after the (in)applicability timer expires, according to an example implementation of the present disclosure. The wireless communications system may be, for example, a 3GPP network, such as, the 5G/5G-A or the 6th generation (6G) NR system. The UE 101 may be any of the UEs 101A-101C and the network node 290 may be the BS 103 shown in FIG. 1 or any other network entity, for example, an LMF server.

Steps 1 to 2 and 5 to 6 of the sequence diagram 400 are similar to the corresponding steps of the sequence diagram 200, shown in FIG. 2. To maintain clarity, Steps 1 to 2 and 5 to 6 are not shown in FIG. 4.

As shown in FIG. 4, in addition to receiving (at Step 3) the full inference configuration (e.g., the CSI-ReportConfig and one or more legacy configurations), the UE may receive (at Step 3) the configuration for the (in)applicability reporting timer. The UE may then start the (in)applicability reporting timer. The period of the (in)applicability reporting timer is shown by the double arrow line 410. The UE may submit (at Step 4) the applicability report for the AI/ML configuration in an RRC message (e.g., in an RRCReconfigurationComplete message), or a UAI, after the configured timer expires, regardless of whether some or all functionalities are (in)applicable. The submission of the applicability report after the configured timer expires (at time 420), in some embodiments, may imply the UE side issues, and that UE may not be ready to receive new/updated configuration(s).

### Case 2

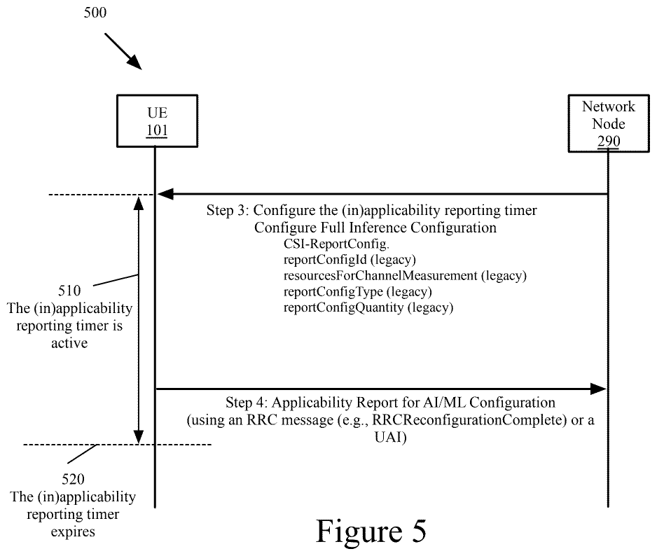

FIG. 5 is a sequence diagram 500 illustrating a portion of an example message flow of a signaling framework for reporting the applicable functionality before the (in)applicability timer expires, according to an example implementation of the present disclosure. The wireless communications system may be, for example, a 3GPP network, such as, the 5G/5G-A or the 6th generation (6G) NR system. The UE 101 may be any of the UEs 101A-101C and the network node 290 may be the BS 103 shown in FIG. 1 or any other network entity, for example, an LMF server.

Steps 1 to 2 and 5 to 6 of the sequence diagram 500 are similar to the corresponding steps of the sequence diagram 200, shown in FIG. 2. To maintain clarity, Steps 1 to 2 and 5 to 6 are not shown in FIG. 5.

As shown in FIG. 5, in addition to receiving (at Step 3) the full inference configuration (e.g., the CSI-ReportConfig and one or more legacy configurations), the UE may receive (at Step 3) the configuration for the (in)applicability reporting timer. The UE may then start the (in)applicability reporting timer. The period of the (in)applicability reporting timer is shown by the double arrow line 510. The UE may submit (at Step 4) the applicability report for the AI/ML configuration in an RRC message (e.g., in an RRCReconfigurationComplete message), or a UAI, before the configured timer expires, regardless of whether some or all functionalities are (in)applicable. For example, the UE 101 may identify identifying some functionalities as applicable and others as inapplicable.

The submission of the applicability report within the pre-defined time window 510 (between the start and expiration of the timer), in some embodiments, may imply the inapplicability may be due to reasons other than the UE side internal conditions or issues. In this case, the network node 290 may use the MAC CE, DCI, or other RRC messages to request the cause for inapplicability if needed or if not already included in the RRC message sent by the UE.

### Case 3

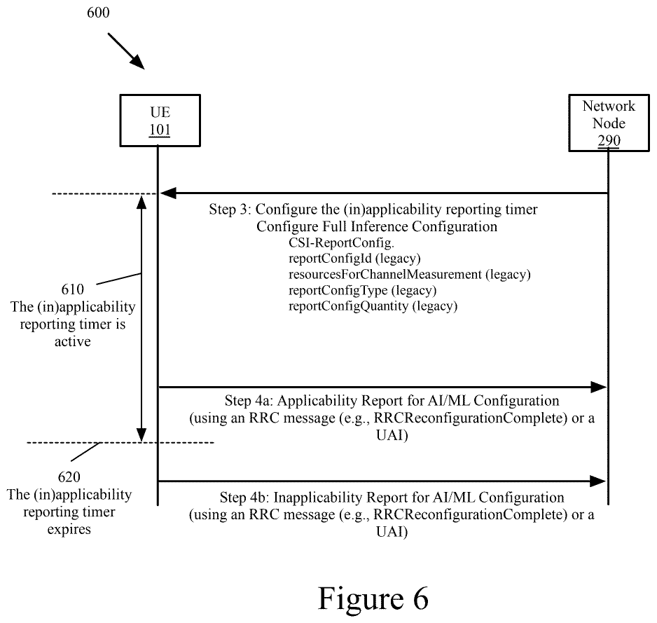

FIG. 6 is a sequence diagram 600 illustrating a portion of an example message flow of a signaling framework for reporting the applicable functionality before the (in)applicability timer expires and reporting the inapplicable functionality after the (in)applicability timer expires, according to an example implementation of the present disclosure. The wireless communications system may be, for example, a 3GPP network, such as, the 5G/5G-A or the 6th generation (6G) NR system. The UE 101 may be any of the UEs 101A-101C and the network node 290 may be the BS 103 shown in FIG. 1 or any other network entity, for example, an LMF server.

Steps 1 to 2 and 5 to 6 of the sequence diagram 600 are similar to the corresponding steps of the sequence diagram 200, shown in FIG. 2. To maintain clarity, Steps 1 to 2 and 5 to 6 are not shown in FIG. 6.

As shown in FIG. 6, in addition to receiving (at Step 3) the full inference configuration (e.g., the CSI-ReportConfig and one or more legacy configurations), the UE may receive (at Step 3) the configuration for the (in)applicability reporting timer. The UE may then start the (in)applicability reporting timer. The period of the (in)applicability reporting timer is shown by the double arrow line 610.

In the example of FIG. 6, if no UE side issues exist, the reporting of both applicable and inapplicable functionalities may be done in Step 4a, before the timer expires (the (in)applicability reporting timer is shown to expire at time point 620). On the other hand, if a UE side issue exists, the applicable functionalities may be reported in Step 4a, before the timer expires, and the inapplicable functionality(s) may be reported in Step 4b after the timer has expired.

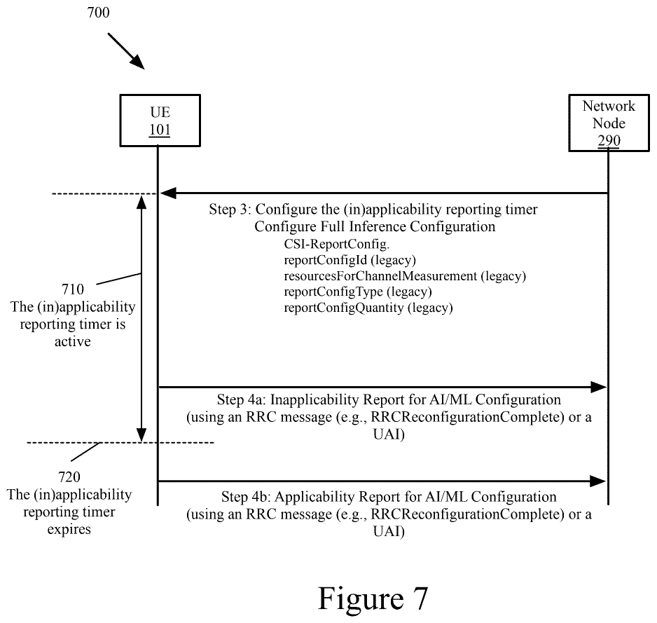

FIG. 7 is a sequence diagram 700 illustrating a portion of an example message flow of a signaling framework for reporting the inapplicable functionality before the (in)applicability timer expires and reporting the applicable functionality after the (in)applicability timer expires, according to an example implementation of the present disclosure.

The sequence diagram 700 is similar to the sequence diagram 600, shown in FIG. 6, except that the inapplicable functionality in FIG. 7 is reported in Step 4a, before the (in)applicability timer expires and the applicable functionality is reported in Step 4b, after the (in)applicability timer expires.

In the example of FIG. 7, if no UE side issues exist, the reporting of both applicable and inapplicable functionalities may be done in Step 4a, before the timer expires (the period of the (in)applicability reporting timer is shown by the double arrow line 710, and its expiration is shown at time point 720). On the other hand, if a UE side issue exists, the inapplicable functionalities may be reported in Step 4a, before the timer expires, and the applicable functionalities may be reported in Step 4b after the timer has expired.

It should be noted that, in general, reporting of (in)applicability may be done with or without the cause. In some embodiments, if the (in)applicability timer expires, and neither applicability or inapplicability report is sent to the network node 290, the UE 101 may switch to legacy (non-AI/ML) configuration or may keep using an AI/ML configuration that is already configured.

The following is applicable to solution 6. For the subsequent evaluation and reporting of (in)applicability functionality(s), the network may configure a recurring or event-triggered timer for subsequent UAI reporting to ensure timely updates on functionality applicability especially the configurations already provided by the network to the UE.
Initial Report: The UE may evaluate its functionalities and send an initial (in)applicability report in an RRC message, such as the RRCReconfigurationComplete message, within or outside the initial network-configured timer as discussed above.
Subsequent Reporting: After the initial report, the UE may continuously monitor changes in configuration and functionality applicability (e.g., due to environmental shifts, network conditions, internal state, etc.) and may prepare subsequent reports via UAI, governed by the recurring or event-triggered timer. The UE may adhere to the network-configured timer (e.g., a periodic interval or a timeout following a triggering event like a functionality status change). The following cases may be used in different embodiments for subsequent reporting.
Case 1—UAI Reporting Occurs After Timer Expires: If the UE submits a UAI message after the configured timer expires (whether reporting all functionalities as inapplicable, all applicable, or a combination), it may imply the UE side issues, and that the UE may not be ready to receive new/updated configuration(s).
Case 2—UAI Reporting Occurs Within Timer: If the UE submits a UAI message within the timer, indicating applicability and inapplicability of functionalities, this may imply inapplicability may be due to other reasons than UE side internal conditions or issues. In this case, the network may use MAC CE, DCI, or other RRC messages to request the cause for inapplicability, if needed.
Case 3—The reporting of (in)applicable functionalities is done within the timer if no UE side issues exist. If the UE side issue exists, the applicable functionalities may be reported within the timer, and the inapplicable functionality(s) may be reported after the timer has expired. In another embodiment, when the functionality change occurs, the UE may report both applicable and inapplicable functionalities after the timer expires.
Case 3a—When the UE detects a change in applicability, the UE may start the timer. During the timer, the UE may wait for the applicability status stability. The UE may send a UAI update on the applicability status once the timer expires. This may help in reducing frequent UAI updates based on applicability changes.
Timer Adaptation: Based on the UAI reporting patterns, the network may adjust the timer duration or frequency (e.g., shortening it for critical functionalities or dynamic conditions, or lengthening it for stable conditions) to optimize responsiveness and resource use.

The network and the UE may log the timing and content of each UAI report. The network and the UE may address internal UE issues for delayed reports, investigate the network/external factors for timely (in)applicability reports as well as (in)applicability reports after the expiry of the timer, and verify successful autonomous activation of applicable functionalities.
Recurring Timer: The network may configure a periodic timer (e.g., every 10 seconds or as needed) for the UE to send UAI reports, ensuring regular updates on functionality status.
Event-Triggered Timer: Alternatively, the timer may reset and start upon a detected change in the applicability (e.g., a functionality becoming applicable or inapplicable), requiring the UE to report within a specified window after the event.
Diagnostic continuation: The timer-based approach maintains its diagnostic utility—delays in UAI reporting point to internal UE issues, while timely reports shift focus to the network/external causes for inapplicability.
Autonomous Activation: For subsequent UAI reports within the timer, the UE may retain the ability to activate newly applicable functionalities autonomously, enhancing efficiency and reducing network signaling overhead.

### Solution 7

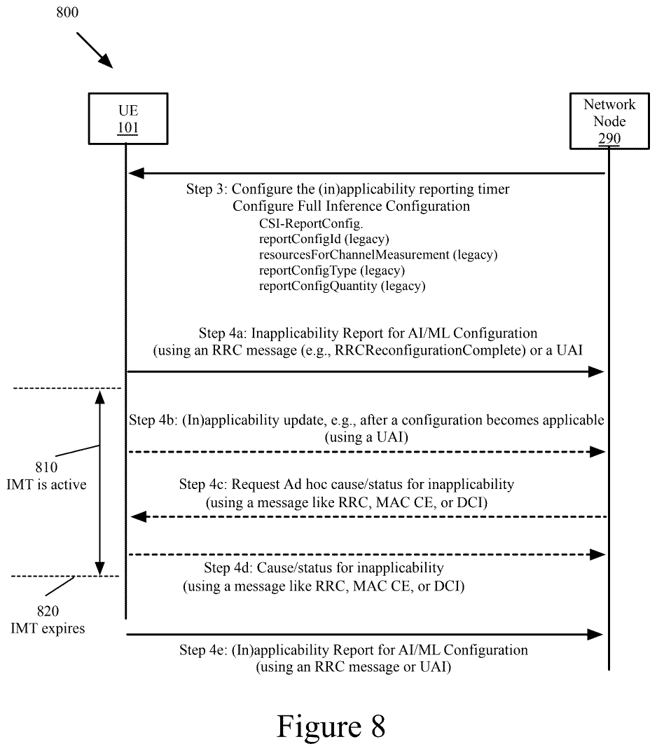

Some embodiments may use an (in)applicability monitoring timer (IMT). FIG. 8 is a sequence diagram 800 illustrating a portion of an example message flow of a signaling framework for reporting the (in)applicable functionality using an IMT timer, according to an example implementation of the present disclosure. The wireless communications system may be, for example, a 3GPP network, such as, the 5G/5G-A or the 6th generation (6G) NR system. The UE 101 may be any of the UEs 101A-101C and the network node 290 may be the BS 103 shown in FIG. 1 or any other network entity, for example, an LMF server.

Steps 1 to 2 and 5 to 6 of the sequence diagram 800 are similar to the corresponding steps of the sequence diagram 200, shown in FIG. 2. To maintain clarity, Steps 1 to 2 and 5 to 6 are not shown in FIG. 8.

In the example of FIG. 8, upon receiving a full inference configuration (at Step 3) from the network node 290, the UE 101 may evaluate its functionalities. The UE 101 may send an initial applicability report (at Step 4a) via an RRC message (e.g., an RRCReconfigurationComplete message, or a UAI), specifying which functionalities are applicable and which are inapplicable, within an initial network-configured timer (e.g., similar to the (in)applicability reporting timer described above with reference to FIGS. 4-7).

After transmitting (at Step 4a) the RRC message (e.g., the RRCReconfigurationComplete message), or a subsequent UAI report, indicating change in applicability (e.g., one or more functionalities as inapplicable or applicable), the UE may prepare to initiate the IMT.

The IMT duration may either be predefined by the UE (e.g., based on the internal logic of the UE or manufacturer settings) or configured by the network via prior signaling (e.g., within the inference configuration or RRC messaging).

The network, in some embodiments, may start the IMT. For example, the network may explicitly signal the UE to start the IMT for the reported inapplicable functionalities (e.g., via a dedicated RRC message or a flag in the inference configuration). The UE may begin the IMT only upon receiving this command.

The network may also stop the IMT. The network, under some conditions, may signal the UE to stop the IMT prematurely (e.g., if the network determines external factors are resolved or diagnostics are unnecessary), overriding the UE's autonomous timing. If no network command is received, the UE may start the IMT autonomously after reporting inapplicability, based on a default behavior configured by the network or UE implementation.

While the IMT is active (as shown by 810), either started by the UE or network, the UE may monitor the status of functionalities or configurations reported as both applicable and inapplicable.

If any configuration or functionality becomes applicable (e.g., due to improved conditions), the UE may immediately send (at Step 4b) a UAI update to the network, activate those functionalities autonomously, and reset the IMT for any remaining (in)applicable functionalities (unless the IMIT is stopped by the network).

At any time (either while the IMT is active or after the IMT expiration) the network node 290 may send (at Step 4c) a request for ad hoc cause (or the status for) inapplicability using a message like RRC, MAC CE, or DCI. In response, the UE 101 may send the cause (or the status for) inapplicability to the network node 290 using a message like RRC, MAC CE, or DCI.

For the applicable functionalities reported in an RRC message (e.g., the RRCReconfigurationComplete message) or the UAI, the UE may activate them immediately. The IMT may apply to both inapplicable and applicable set of functionality or configuration either in a joint manner or individually or separately.
Case 1—No Change Reported before the IMT Expires: If the IMT expires, at time point 820, (without being stopped by the network) and no UAI update is sent, the network may assume potential UE-side issues (e.g., hardware malfunction, software freeze, or inability to adapt) as the reason for persistent inapplicability. Alternatively, an explicit UAI update may be sent indicating persistent inapplicability after the timer has expired.
Case 2—Change Reported Within IMT: If the UE sends a UAI update within the IMT period 810 (as shown in Step 4b) indicating a change in applicability (one or more previously inapplicable functionalities are now applicable (or applicable functionalities are now inapplicable), the network may interpret this as normal UE operation.
Case 3—Change Reported after the IMT Expires: If the change of applicability is reported (as shown at Step 4e) after the IMT expires, the network may interpret this as the existence of the UE side issues.

Upon the IMT expiration with no UAI update, the network may log the lack of change as an indication of potential internal UE problems. The network may stop the IMT (if still active) and initiate diagnostic actions, such as sending a troubleshooting command, requesting a detailed UE status report, or transmitting an RRC message (e.g., the RRCReconfiguration message) to the UE to reset the UE's state or provide a new configuration.

If a UAI update is sent within the IMT indicating newly (in)applicable functionalities, the UE may activate them autonomously, and the network acknowledges the update, resetting its assumptions about UE-side issues.

For functionalities that remain inapplicable, the UE may restart the IMT (if not stopped by the network). The network may stop the IMT if the network determines ongoing monitoring is unnecessary (e.g., the external issues are resolved) or start a new IMT for a different subset of inapplicable functionalities.

### Optimize and Iterate

The network, in some embodiments, may dynamically adjust the IMT's start/stop behavior or duration based on the observed patterns (e.g., frequent updates may prompt stopping the IMT earlier, while persistent issues may extend it). The UE may adhere to the network commands while maintaining its ability to report changes autonomously within the IMT, ensuring a balance of control and responsiveness. The outcomes (expiration vs. timely updates) may be documented to refine network policies and UE configurations.

The following is an example of the network and UI behavior and several exemplary outcomes. In the initial report, the UE reports the functionality or configuration A as applicable and the functionality or configuration B as inapplicable via and RCC message, such as the RRCReconfigurationComplete message. The UE activates A (if full configuration is provided in step 3 of FIG. 8). The network signals the UE to start a 30-second IMT for B.
Outcome 1: After 10 seconds, B becomes applicable. The UE sends UAI, activates B, and the network stops the IMT, noting normal operation.
Outcome 2: After 20 seconds, the network stops the IMT (e.g., due to resolved external issues); no UE-side issue is assumed.
Outcome 3: After 15 seconds, the UE reports inapplicability of A (with/without cause) and applicability of B.
Outcome 4: After 15 seconds, the UE reports inapplicability of both A and B (with/without cause).
Outcome 5: After 30 seconds, IMT expires with no UAI; the network assumes a UE-side issue with B and initiates diagnostics.
Outcome 6: After 30 seconds, IMT expires the UE sends a UAI with or without cause with the (in)applicability report.
Outcome 7: After 30 seconds, IMT expires with no UAI; the network assumes nothing.
Outcome 8: After 30 seconds, IMT expires the UE sends a UAI with/without cause with (in) applicability report and mark only legacy non-AI configuration as applicable. The network assumes a UE-side issue.

The IMT may be both per functionality/configuration or may be considered as an instance monitoring applicability of one or more functionality/configurations.

It should be noted in different embodiment, both inapplicability and applicability may be reported explicitly, the configuration may be full or partial, the applicability report may or may not contain the cause, and the reporting may be periodic, aperiodic, or semi-persistent.

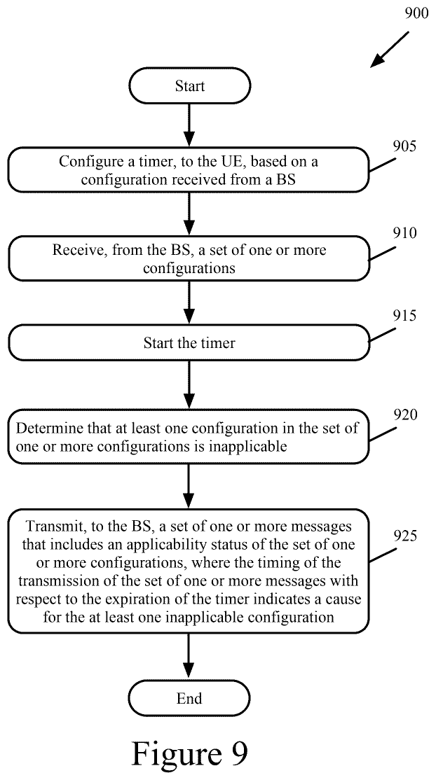

FIG. 9 illustrates a flowchart of an example method/process 900 of monitoring and reporting causes of change in configuration or functionality applicability, according to an example implementation of the present disclosure. The process 900 may be performed by at least one processor of the terminal device 101, shown in FIGS. 4-7.

The process 900 may configure (at block 905) a timer, to the UE, based on a configuration received from a BS. For example, the process 900 may receive the configuration for the (in)applicability reporting timer as described above with reference to Step 3 of FIGS. 4-7.

The process 900 may receive (at block 910), from the BS, a set of one or more configurations. For example, the process 900 may receive the configurations as described above with reference to Step 3 of FIGS. 4-7.

The process 900 may start (at block 915) the timer. The process 900 may determine (at block 920) that at least one configuration in the set of one or more configurations is inapplicable.

The process 900 may transmit (at block 925), to the BS, a set of one or more messages that includes an applicability status of the set of one or more configurations. The timing of the transmission of the set of one or more messages with respect to the expiration of the timer may indicate a cause for the at least one inapplicable configuration. The process 900 may then end.

In some embodiments, transmitting (at block 925) the set of one or more messages may include the following. In a case that the inapplicability of the at least one configuration is due to a UE-side issue: transmitting may include transmitting, to the BS, a first message that includes the applicability status of the set of one or more configurations after the expiration of the timer (e.g., as described above with reference to initial reporting in Case 1, Solution 6). In a case that the inapplicability of the at least one configuration is not due to a UE-side issue: transmitting (at block 925) may include, transmitting, to the BS, a second message that includes the applicability status of the set of one or more configurations before the expiration of the timer (e.g., as described above with reference to initial reporting in Case 2, Solution 6).

In some embodiments, the process 900 may determine that at least one configuration in the set of one or more configurations is applicable. In these embodiments, transmitting (at block 925) the set of one or more messages may include the following. In a case that the inapplicability of the at least one configuration is not due to a UE-side issue (e.g., as described above with reference to initial reporting in Case 3, Solution 6 where the inapplicability is not due to a UE-side issue): transmitting, to the BS, a first message that includes the applicability status of the at least one configuration in the set of one or more configurations that is applicable before the expiration of the timer, and transmitting, to the BS, a second message that includes the applicability status of the at least one configuration in the set of one or more configurations that is inapplicable before the expiration of the timer.

In some embodiments, transmitting (at block 925) the set of one or more messages further includes the following. In a case that the inapplicability of the at least one configuration is due to a UE-side issue (e.g., as described above with reference to initial reporting in Case 3, Solution 6 where the inapplicability is due to a UE-side issue): transmitting, to the BS, a first message that includes the applicability status of the at least one configuration in the set of one or more configurations that is applicable before the expiration of the timer, and transmitting, to the BS, a second message that includes the applicability status of the at least one configuration in the set of one or more configurations that is inapplicable after the expiration of the timer.

In some embodiments, transmitting (at block 925) the set of one or more messages further includes the following. In a case that the inapplicability of the at least one configuration is due to a UE-side issue (e.g., as described above with reference to initial reporting in Case 3, Solution 6 where the inapplicability is due to a UE-side issue): transmitting, to the BS, a first message that includes the applicability status of the at least one configuration in the set of one or more configurations that is applicable after the expiration of the timer, and transmitting, to the BS, a second message that includes the applicability status of the at least one configuration in the set of one or more configurations that is inapplicable before the expiration of the timer.

In some embodiments, the process 900 may determine a change in the applicability or inapplicability of a first configuration in the set of one or more configurations. The process 900 start a second timer. In a case that the inapplicability of the at least one configuration is due to a UE-side issue (e.g., as described above with reference to subsequent reporting in Case 1, Solution 6): the process 900 may transmit, to the BS, a first messages that includes the applicability status of the set of one or more configurations after the expiration of the second timer. In a case that the inapplicability of the at least one configuration is not due to a UE-side issue (e.g., as described above with reference to subsequent reporting in Case 2, Solution 6): the process 900 may transmit, to the BS, a second messages that includes the applicability status of the set of one or more configurations before the expiration of the second timer.

In some embodiments, the process 900 may determine that at least one configuration in the set of one or more configurations is applicable. The process 900 may start a second timer. In a case that the inapplicability of the at least one configuration is not due to a UE-side issue (e.g., as described above with reference to subsequent reporting in Case 3, Solution 6, where the inapplicability is not due to a UE-side issue): the process 900 may transmit, to the BS, a first message that includes the applicability status of the at least one configuration in the set of one or more configurations that is applicable before the expiration of the second timer, and transmit, to the BS, a second message that includes the applicability status of the at least one configuration in the set of one or more configurations that is inapplicable before the expiration of the second timer.

In some embodiments (e.g., as described above with reference to subsequent reporting in Case 3, Solution 6, where the inapplicability is due to a UE-side issue), in a case that the inapplicability of the at least one configuration is due to a UE-side issue: the process 900 may transmit, to the BS, a first message that includes the applicability status of the at least one configuration in the set of one or more configurations that is applicable before the expiration of the second timer, and transmit, to the BS, a second message that includes the applicability status of the at least one configuration in the set of one or more configurations that is inapplicable after the expiration of the second timer.

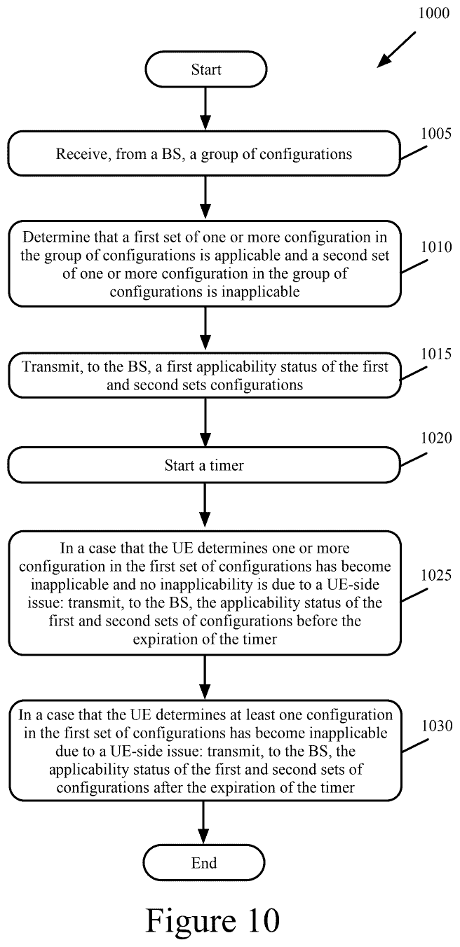

FIG. 10 illustrates a flowchart of an example method/process 1000 of monitoring and reporting causes of change in configuration or functionality applicability based an (in)applicability monitoring timer, according to an example implementation of the present disclosure. The process 1000 may be performed by at least one processor of the terminal device 101, shown in FIG. 8.

The process 1000 may receive (at block 1005), from a BS, a group of configurations.

The process 1000 may determine (at block 1010) that a first set of one or more configuration in the group of configurations is applicable and a second set of one or more configuration in the group of configurations is inapplicable.

The process 1000 may transmit (at block 1015), to the BS, a first applicability status of the first and second sets configurations. The process 1000 may start (at block 1020) a timer. The UE, in some embodiments, may start the timer in response to receiving, from the BS, an indication to start the timer. The UE, in other embodiments, may start the timer based on the UE's internal logic or based on a default configuration.

In a case that the UE determines one or more configuration in the first set of configurations has become inapplicable and no inapplicability is due to a UE-side issue: the process 1000 may transmit (at block 1025), to the BS, the applicability status of the first and second sets of configurations before the expiration of the timer

In a case that the UE determines at least one configuration in the first set of configurations has become inapplicable due to a UE-side issue: the process 1000 may transmit (at block 1030), to the BS, the applicability status of the first and second sets of configurations after the expiration of the timer. The process 1000 may then end.

In some embodiments (e.g., as described above with reference to sending an explicit message in Solution 7, case 1), in a case that the UE determines no change in the applicability of the second set of configurations prior to the expiration of the timer: the process 1000 may transmit, to the BS, a message indicating a persistent inapplicability of the configurations in the second set of one or more configurations.

In some embodiments (e.g., as described above with reference to sending no messages in Solution 7, case 1), in a case that the UE determines no change in the applicability of the second set of one or more configurations prior to the expiration of the timer: the process 1000 may transmit no applicability status to the BS to imply a persistent inapplicability of the configurations in the second set of one or more configurations.

In some embodiments, the process 1000 may determine at least one configuration in the second set of one or more configurations has become applicable; may transmit, to the BS, the applicability status of the first and second sets of configurations, may activate the at least one configuration in the second set of one or more configurations, may remove the at least one configuration from the second set of one or more configurations; and in case that any configuration in the second set of one or more configurations remains inapplicable: may restart the timer for the second set of one or more configurations.

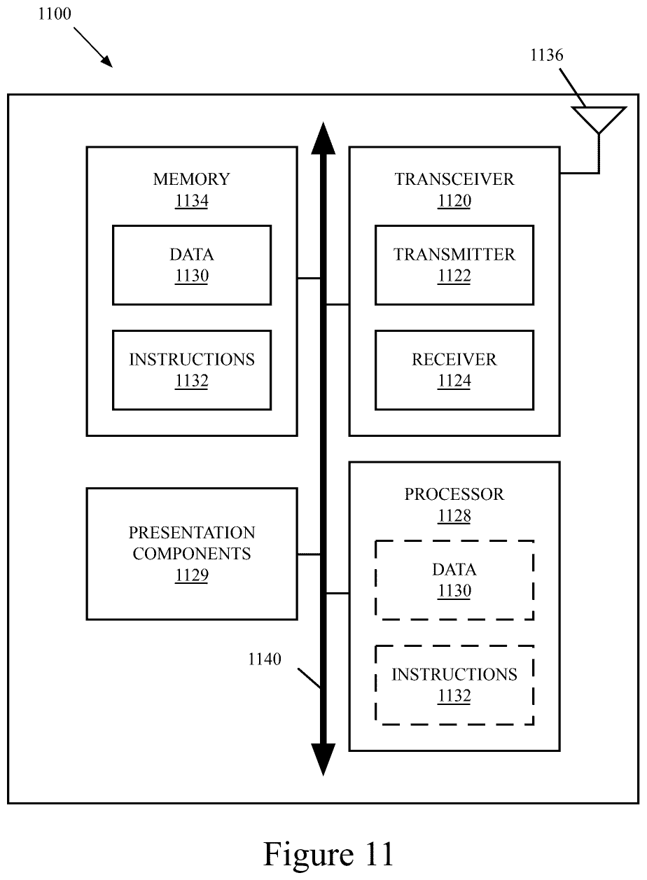

FIG. 11 is a block diagram illustrating a node 1100 for wireless communication, according to an example implementation of the present disclosure. As illustrated in FIG. 11, a node 1100 may include a transceiver 1120, a processor 1128, a memory 1134, one or more presentation components 1129, and at least one antenna 1136. The node 1100 may also include a radio frequency (RF) spectrum band module, a BS communications module, a network communications module, and a system communications management module, Input/Output (I/O) ports, I/O components, and a power supply (not illustrated in FIG. 11).

Each of the components may directly or indirectly communicate with each other over one or more buses 1140. The node 1100 may be a UE, a BS, a LMF server, or any other network node on the RAN side or CN side that performs various functions disclosed with reference to FIGS. 1 through 10.

The transceiver 1120 has a transmitter 1122 (e.g., transmitting/transmission circuitry) and a receiver 1124 (e.g., receiving/reception circuitry) and may be configured to transmit and/or receive time and/or frequency resource partitioning information. The transceiver 1120 may be configured to transmit in different types of subframes and slots including, but not limited to, usable, non-usable, and flexibly usable subframes and slot formats. The transceiver 1120 may be configured to receive data and control channels.

The node 1100 may include a variety of computer-readable media. Computer-readable media may be any available media that may be accessed by the node 1100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1134 may include computer-storage media in the form of volatile and/or non-volatile memory. The memory 1134 may be removable, non-removable, or a combination thereof. Example memory may include solid-state memory, hard drives, optical-disc drives, etc. As illustrated in FIG. 11, the memory 1134 may store a computer-readable and/or computer-executable instructions 1132 (e.g., software codes) that are configured to, when executed, cause the processor 1128 to perform various functions disclosed herein, for example, with reference to FIGS. 1 through 10. Alternatively, the instructions 1132 may not be directly executable by the processor 1128 but may be configured to cause the node 1100 (e.g., when compiled and executed) to perform various functions disclosed herein.

The processor 1128 (e.g., having processing circuitry) may include an intelligent hardware device, e.g., a Central Processing Unit (CPU), a microcontroller, an ASIC, etc. The processor 1128 may include memory. The processor 1128 may process the data 1130 and the instructions 1132 received from the memory 1134, and information transmitted and received via the transceiver 1120, the baseband communications module, and/or the network communications module. The processor 1128 may also process information to send to the transceiver 1120 for transmission via the antenna 1136 to the network communications module for transmission to a CN.

One or more presentation components 1129 may present data indications to a person or another device. Examples of presentation components 1129 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
configure a timer, to the UE, based on a configuration received from a base station (BS);
receive, from the BS, a set of one or more configurations;
start the timer;
determine that at least one configuration in the set of one or more configurations is inapplicable; and
transmit, to the BS, a set of one or more messages comprising an applicability status of the set of one or more configurations,
wherein a timing of the transmission of the set of one or more messages with respect to an expiration of the timer indicates a cause for the at least one inapplicable configuration in the set of one or more configurations.

2. The UE of claim 1, wherein transmitting the set of one or more messages comprising the applicability status of the set of one or more configurations comprises:
in a case that the inapplicability of the at least one configuration is due to a UE-side issue:
transmitting, to the BS, a first message comprising the applicability status of the set of one or more configurations after the expiration of the timer, and
in a case that the inapplicability of the at least one configuration is not due to a UE-side issue:
transmitting, to the BS, a second message comprising the applicability status of the set of one or more configurations before the expiration of the timer.

3. The UE of claim 1,
wherein the at least one processor is further configured to execute the one or more computer-executable instructions to cause the UE to:
determine that at least one configuration in the set of one or more configurations is applicable,
wherein transmitting the set of one or more messages comprising the applicability status of the set of one or more configurations comprises:
in a case that the inapplicability of the at least one configuration is not due to a UE-side issue:
transmitting, to the BS, a first message comprising the applicability status of the at least one configuration in the set of one or more configurations that is applicable before the expiration of the timer, and
transmitting, to the BS, a second message comprising the applicability status of the at least one configuration in the set of one or more configurations that is inapplicable before the expiration of the timer.

4. The UE of claim 3,
wherein transmitting the set of one or more messages comprising the applicability status of the set of one or more configurations further comprises:
in a case that the inapplicability of the at least one configuration is due to a UE-side issue:
transmitting, to the BS, a first message comprising the applicability status of the at least one configuration in the set of one or more configurations that is applicable before the expiration of the timer, and
transmitting, to the BS, a second message comprising the applicability status of the at least one configuration in the set of one or more configurations that is inapplicable after the expiration of the timer.

5. The UE of claim 3,
wherein transmitting the set of one or more messages comprising the applicability status of the set of one or more configurations further comprises:
in a case that the inapplicability of the at least one configuration is due to a UE-side issue:
transmitting, to the BS, a first message comprising the applicability status of the at least one configuration in the set of one or more configurations that is applicable after the expiration of the timer, and
transmitting, to the BS, a second message comprising the applicability status of the at least one configuration in the set of one or more configurations that is inapplicable before the expiration of the timer.

6. The UE of claim 1,
wherein the timer is a first timer,
wherein the at least one processor is further configured to execute the one or more computer-executable instructions to cause the UE to:
determine a change in the applicability or inapplicability of a first configuration in the set of one or more configurations,
start a second timer,
in a case that the inapplicability of the at least one configuration is due to a UE-side issue:
transmit, to the BS, a first messages comprising the applicability status of the set of one or more configurations after the expiration of the second timer, and
in a case that the inapplicability of the at least one configuration is not due to a UE-side issue:
transmit, to the BS, a second messages comprising the applicability status of the set of one or more configurations before the expiration of the second timer.

7. The UE of claim 1,
wherein the timer is a first timer,
wherein the at least one processor is further configured to execute the one or more computer-executable instructions to cause the UE to:
determine that at least one configuration in the set of one or more configurations is applicable,
start a second timer,
in a case that the inapplicability of the at least one configuration is not due to a UE-side issue:
transmit, to the BS, a first message comprising the applicability status of the at least one configuration in the set of one or more configurations that is applicable before the expiration of the second timer, and
transmit, to the BS, a second message comprising the applicability status of the at least one configuration in the set of one or more configurations that is inapplicable before the expiration of the second timer.

8. The UE of claim 7,
wherein the at least one processor is further configured to execute the one or more computer-executable instructions to cause the UE to:
in a case that the inapplicability of the at least one configuration is due to a UE-side issue:
transmit, to the BS, a first message comprising the applicability status of the at least one configuration in the set of one or more configurations that is applicable before the expiration of the second timer, and
transmit, to the BS, a second message comprising the applicability status of the at least one configuration in the set of one or more configurations that is inapplicable after the expiration of the second timer.

9. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from the BS, a plurality of configurations;
determine that a first set of one or more configuration in the plurality of configurations is applicable and a second set of one or more configuration in the plurality of configurations is inapplicable;
transmit, to the BS, a first applicability status of the first and second sets configurations;
start a timer;
in a case that the UE determines one or more configuration in the first set of configurations has become inapplicable, and no inapplicability is due to a UE-side issue:
transmit, to the BS, the applicability status of the first and second sets of configurations before an expiration of the timer; and
in a case that the UE determines at least one configuration in the first set of configurations has become inapplicable due to a UE-side issue:
transmit, to the BS, the applicability status of the first and second sets of configurations after the expiration of the timer.

10. The UE of claim 9,
wherein the at least one processor is further configured to execute the one or more computer-executable instructions to cause the UE to:
in a case that the UE determines no change in the applicability of the second set of configurations prior to the expiration of the timer:
transmit, to the BS, a message indicating a persistent inapplicability of the configurations in the second set of one or more configurations.

11. The UE of claim 9,
wherein the at least one processor is further configured to execute the one or more computer-executable instructions to cause the UE to:
in a case that the UE determines no change in the applicability of the second set of one or more configurations prior to the expiration of the timer:
transmit no applicability status to the BS to imply a persistent inapplicability of the configurations in the second set of one or more configurations.

12. The UE of claim 9,
wherein the at least one processor is further configured to execute the one or more computer-executable instructions to cause the UE to:
determine at least one configuration in the second set of one or more configurations has become applicable;
transmit, to the BS, the applicability status of the first and second sets of configurations;
activate the at least one configuration in the second set of one or more configurations;
remove the at least one configuration from the second set of one or more configurations; and
in case that any configuration in the second set of one or more configurations remains inapplicable:
restart the timer for the second set of one or more configurations.

13. The UE of claim 9, wherein:
starting the timer comprises starting the timer in response to receiving, from the BS, an indication to start the timer.

14. The UE of claim 9, wherein:
starting the timer comprises starting the timer by the UE based on a default configuration.

15. A method, comprising:
configuring a timer, by a user equipment (UE), based on a configuration received from a base station (BS);
receiving, by the UE, from the BS, a set of one or more configurations;
determining, by the UE, that at least one configuration in the set of one or more configurations is inapplicable;
starting, by the UE, the timer; and
transmitting, by the UE, to the BS, an applicability status of the set of one or more configurations,
wherein a timing of the transmission of the applicability report with respect to an expiration of the timer indicates a cause for the at least one inapplicable configuration in the set of one or more configurations.
